(19) United States
(12) Patent Application Publication
(10) Pub. No.: US 2019/0374876 A1
(43) Pub. Date: Dec. 12, 2019

(54) NOVEL MULTIMODAL OSCILLATORY CHROMATOGRAPHIC PURIFICATION SYSTEM

(71) Applicant: Michael Dale Hilgert, Fairland, IN (US)

(72) Inventor: Michael Dale Hilgert, Fairland, IN (US)

(21) Appl. No.: 16/513,652

(22) Filed: Jul. 16, 2019

Related U.S. Application Data
(63) Continuation-in-part of application No. 15/200,138, filed on Jul. 1, 2016, now abandoned.

(51) Int. Cl. B01D 15/34; B01D 15/42; B01D 15/32; B01D 15/22; B01D 15/18; G01N 30/34; G01N 30/60

(52) U.S. Cl. CPC B01D 15/34; B01D 15/426; B01D 15/325; B01D 15/22; G01N 30/6069; B01D 15/1814; G01N 30/34; G01N 30/6039; B01D 15/1871

(57) ABSTRACT

The present invention comprises a novel multimodal chromatography sequence of short length alternating adsorption and size exclusion media operating with gradient elution. The novel multimodal chromatography in an oscillating series utilizes the alternating solvent exchange media to reposition the active region of separation back in phase with the target solutes. Each solvent exchange column bed length in the sequence is designed to achieve a subtle decrease or increase in the solvent gradient (or salt gradient) concentration associated with the two solutes of interest which results in an extension of the active separation or increasing differences in solute velocity for two solutes of interest. The novel oscillatory chromatographic system demonstrates much improved separation capability as shown by a one dimensional model.

This invention is a continuation in part of pending domestic patent application Ser. No. 15/200,138. The specification contains new subject matter to add clarity to the process of making and using the invention.

### FIELD OF THE INVENTION

The invention described herein is intended for use in preparative purification and analytical separation of proteins/peptides using a novel design for a chromatographic purification system. The invention differs from single modal chromatographic purification by utilizing multimodal chromatography in an oscillating series. FIG. 1 illustrates the typical single column purification strategy. FIG. 2 illustrates a novel oscillatory chromatographic method. The novel strategy is accomplished using multiple short columns or one column with alternating media. The example described herein is for a reverse phase chromatographic separation. This novel concept can be applied to other modes of chromatography. A model is described and presented here for a reverse phase chromatographic separation in a novel alternating reverse phase-solvent exchange media design.

### BACKGROUND

As described by use of a gradient elution chromatography model (described herein), a single modal adsorption chromatography column operating in a gradient elution mode is limited because the solid phase interaction with the target solute occurs within a specific mobile phase concentration range. A small region of the mobile phase gradient contributes to the separation. This active region of solvent concentration is depicted in FIG. 4 for a model solute (Insulin) targeted for separation. FIG. 4 shows a theoretical plot of solvent concentration vs. solute velocity. The model system is described in herein. Additionally, the theoretical model used to describe the solute movement is explained herein.

FIG. 5 shows a velocity profile derived from a theoretical model for each of two closely related solutes (named Solute1—Insulin and Solute 2—Desamido) to be separated in a single 30 cm long reverse phase column with gradient elution. The velocity profiles are plotted as solute velocity verse column length. There is minimal difference in the velocity profiles for each solute because they are closely related species. It is observed that the velocity reaches steady state equal to the mobile phase velocity after approximately 15 to 20 cm of bed length and any remaining bed length does not contribute to the separation. The strategy of the novel oscillatory system is to reposition the solvent gradient with respect to the solute positions to move the solutes back into the region of active separation. This is accomplished by using the alternating solvent exchange columns which adjusts the relative position of the small molecule elution gradient profile with respect to the large molecular weight solutes of interest.

### BRIEF SUMMARY OF THE INVENTION

The novel multimodal chromatography in an oscillating series utilizes the alternating solvent exchange media to reposition the active region of separation back in phase with the target solute. The novel oscillatory system is specifically designed to reposition the eluent gradient solvent concentration with respect to the solute positions to move the solutes back into the region of active separation. In the case of the Insulin and Desamido model described herein, the region of active separation is an eluent gradient solvent concentration of 27% to 32%. Each solvent exchange column bed length in the sequence is designed to achieve a subtle repositioning in the solvent concentration associated with the two solutes of interest which results in an extension of the active separation.

Note that the gradient elution with the novel system can be operated in one of three modes:
1. A positive slope gradient designed to accomplish sequential separations in each sequential reverse phase column. A positive slope gradient would be generally applied to all solutes and would allow discrete increasing separation between all components as the separation proceeds through the column sequence. FIG. 3 depicts the novel chromatography system with a positive gradient slope.
2. A negative sloped gradient designed to allow the faster moving component or solute of interest to escape through the column sequence while second solute of interest would be captured by the column sequence and allow an acceleration in the rate of separation between two solutes of interest.

### BRIEF DESCRIPTION OF DRAWINGS

FIG. 1: Single Column Chromatographic Purification System

FIG. 2: Novel Oscillatory Chromatographic Purification System

FIG. 3: Novel Chromatographic System with a Positive Gradient Slope Design

FIG. 4: Plot of Solvent Concentration Verses Solute Velocity for a Protein/peptide Solute (Insulin).

FIG. 5: Plot of Solute Velocity And Solvent Concentration Verses Bed Length for a 30 cm Long Column

FIG. 6: Plot of Effluent Mobile Phase Organic Solvent Concentration for Each Column in a Novel Oscillatory Alternating Positive Gradient Slope Column System

FIG. 7: Plot of Velocity Difference Between Two Protein/Peptide (Insulin/Desamido) Solutes Targeted for Separation using Reverse Phase Chromatography Media

FIG. 8: Plot of solute velocity and solvent concentration verses bed length for Media Sections in a Novel Oscillatory Alternating Positive Gradient Slope Column System

FIG. 9: Plot of Effluent Mobile Phase Organic Solvent Concentration for Each Column in a Novel Oscillatory Alternating Column System with a Negative Gradient Slope System

FIG. 10: Plot of Component 1 and Component 2 Retention Time for Each Sequential Column in a Novel Oscillatory Alternating Column System with a Negative Gradient Slope System

FIG. 11: Plot of solute velocity and solvent concentration verses bed length for rev phase columns in a Novel Oscillatory Alternating Column System with a Negative Gradient Slope System

FIG. 12: Theoretical Elution Gradient for Reverse Phase Chromatography Column generated by Equation 2g

FIG. 13: Plot of Effluent Mobile Phase Organic Solvent Concentration for Each Column in a Novel Oscillatory Alternating Column System with a negative gradient slope—Undesirable Design—Component 1 exit solvent concentration drops too low (component 1 retained by system)

FIG. 14: Plot of Effluent Mobile Phase Organic Solvent Concentration for Each Column in a Novel Oscillatory Alternating Column System with a negative gradient slope—Good Design with Pseudo-Steady State

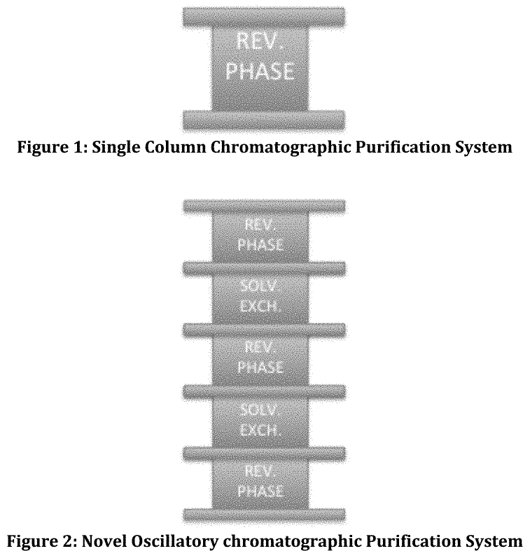

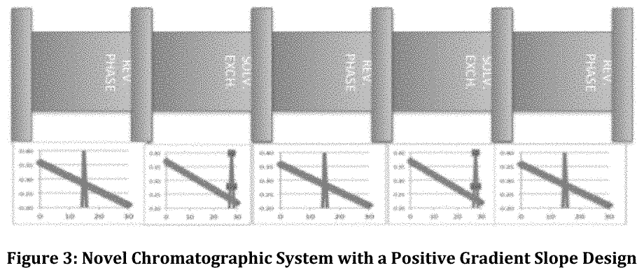

### DETAILED DESCRIPTION OF THE INVENTION

Theoretical modeling is used herein to demonstrate an improved separation using the novel multimodal oscillatory chromatographic purification system. A one-dimensional model is used to describe two challenging separations between two closely related peptides (Insulin/Desamido separation as one example and Porcine Insulin/Desamido as a second example). Additionally the model is applied to the separation of two proteins (Ribonuclease A/Lysozyme) to verify application to higher molecular weight proteins. A reverse phase system is chosen for the detailed description of the invention. This invention extends to any adsorption system.

The Solute velocity dependence on organic solvent concentration in gradient elution with reverse phase chromatography is described by the following standard chromatography solute movement and reverse phase gradient equations:

$${k}_{a}^{′} = \frac{{t}_{a} - {t}_{0}}{{t}_{0}} \qquad Equation 2 a$$

k′ₐ=retention factor for solute of interest (solute a)
tₐ=retention time for solute of interest (solute a)
t₀=retention time for unretained solute
Revise Equation 2a for small column slice

Δtₐ=Δt₀(k′ₐ+1) Equation 2b:

Δtₐ=retention time for solute of interest across small section of column
Δt₀=retention time for unretained solute across small section of column

log k′ₐ=Sϕ+c Equation 2c:

k′ₐ=10^{(sϕ+c)} Equation 2d:

$$S = empirical slope = - 29.898 for component 1 / solute 1 ( \underline{Insulin} ) = - 29.124 for component 2 / solute 2 ( \underline{Desamido} ) for example scenario$$

ø=fractional solvent concentration

$$c = constant = log {k}_{0} = 9.034 for component 1 / solute 1 ( \underline{Insulin} ) = 8.98 for component 2 / solute 2 ( \underline{Desamido} ) for example scenario$$

Utilizing Equation 2b in velocity expression:

$${v}_{a} = \frac{Δ x}{Δ {t}_{a}} = \frac{Δ x}{Δ {t}_{0} ( {k}_{a}^{′} + 1 )} = \frac{v}{{∈}_{τ rpc} ( {k}_{a}^{′} + 1 )} \qquad Equation 2 e$$

vₐ=solute “a” velocity
Δx=small slice of column (small column length or distance)

$$v = mobile phase superficial velocity in \frac{cm}{hr}$$

$$( flowrate \div colum ncross sectional A ) = 100 cm \text{/} hr$$

∈_{Trpc}=rev. phase column total void fraction=0.78 for example scenario

Combining Equation 2e and 2d provides an expression for solute “a” velocity:

$${v}_{a} = \frac{v}{{∈}_{T} [ {10}^{( S φ + c )} + 1 ]} = \frac{[ \frac{v}{{∈}_{Trpc}} ]}{[ {10}^{( S φ + c )} + 1 ]} \qquad Equation 2 f$$

The organic solvent gradient concentration dependence on time and column axial distance in rev phase chromatography is described by the following equation (Equation 2g_{RPC}). Equation 2g_{RPC} is a linear expression for the linear elution gradient in the adsorption media. Equation 2g_{RPC} is derived from the fundamental form of a three dimensional line with ϕ, fractional solvent concentration, as the dependent variable and time (t) and axial distance from the column inlet (x) as the dependent variables. The eluent solvent gradient is a linear gradient with respect to both time and axial distance from the column inlet. The fundamental equation of a 3-dimensional line has one intercept at the ϕ-axis (t=0 and x=0) which is the constant aₒ, the initial elution gradient solvent concentration in decimal form. The slope of the line with respect to the axial distance from the column inlet,

$${[ \frac{Δ a}{Δ x} ]}_{RPC}$$

is a constant slope defined by the change in the elution gradient solvent concentration in fractional form with respect to 1 cm of axial distance from the adsorption media inlet. This constant is defined using a trial and error approach to the system design as described in paragraph [0061] of this specification. The slope of the line with respect to time,

$${\frac{v}{60 {∈}_{Trpc}} [ \frac{Δ a}{Δ x} ]}_{RPC} ,$$

is a constant that accounts for the velocity at which the solvent gradient moves using the total void fraction of the media to convert the superficial velocity to the actual mobile phase velocity. A superficial velocity of 100 cm/hr is a typical velocity used in preparative chromatography. A void fraction of 0.78 is a typical total void fraction for adsorption media. The derivation for the linear gradient movement in the size exclusion column, equation 2g, is similar.

$${ }_{RPC} \text{:} ∅ = {a}_{0} + {\frac{v}{60 {∈}_{Trpc}} [ \frac{Δ a}{Δ x} ]}_{RPC} t + {[ \frac{Δ a}{Δ x} ]}_{RPC} x \qquad Equation 2 g$$

ø=fractional solvent concentration
a₀=initial solvent concentration at t=0 and x=0 (or from previous SEC column)
x=axial distance down the column length (cm)
t=time (mins)
v=mobile phase superficial velocity in cm/hr (flowrate÷column cross sectional A)
∈_{Trpc}=column total void fraction

$${[ \frac{Δ a}{Δ x} ]}_{RPC} = rev . phase colum nsolvent gradient slope$$

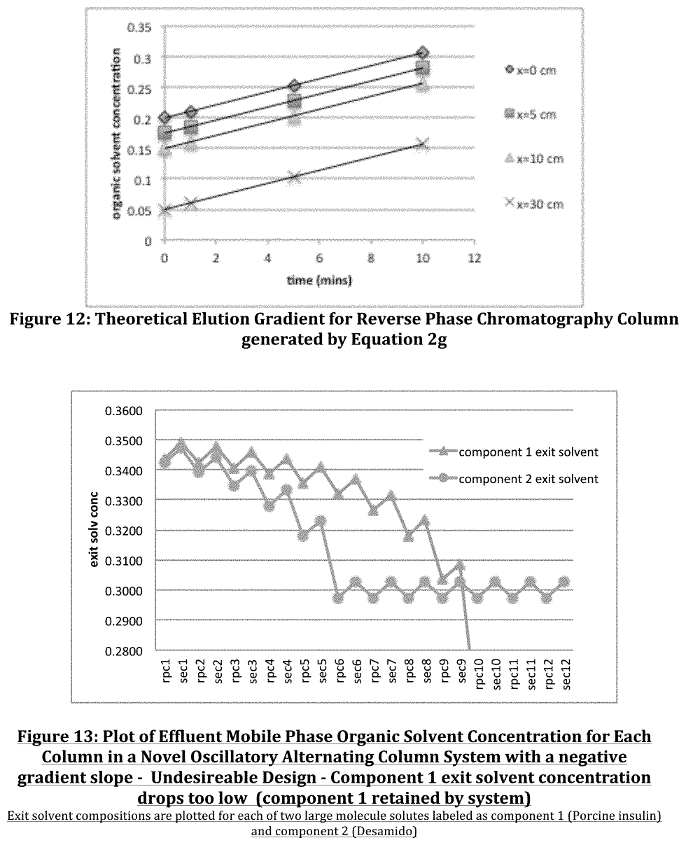

(change in organic solvent conc. per cm of column axial distance)
FIG. 12 shows a plot of the linear elution gradient described by Equation 2g_{RPC} with a₀=0.20.

The expression for elution time, Equation 2j, in a size exclusion (SEC) column is developed from the fundamental expression describing solute movement in SEC columns, equation 2h. Equation 2j is derived from Equation 2h using the relationship of residence time=apparent volume/flow rate. The apparent volume available to the proteins/peptides targeted for separation consists of the void volume external to the size exclusion media and the internal volume of the size exclusion media that has a pore size large enough to be available to the proteins/peptides targeted for separation. The residence time for the proteins/peptides targeted for separation in Equation 2j is represented as: (apparent distance X cross sectional area)/(velocity X cross sectional area). Since the cross sectional area is constant and can be algebraically cancelled out, the residence time consists of apparent distance/superficial velocity. The residence time for the proteins/peptides targeted for separation consists of two terms in Equation 2j. The first term describes the residence time in the void volume external to the size exclusion media,

$$\frac{Z {∈}_{void}}{v}$$

(apparent distance/superficial velocity). The second term describes the residence time internal or inside the size exclusion media consisting of pores large enough to be available to the proteins/peptides targeted for separation. Size exclusion media is selected in the design with K_{sec}=0, meaning that the size exclusion media totally excludes the proteins/peptides targeted for separation. GE Health Care Sephadex LH-20 is an example of a size exclusion media that would exclude Insulin and Desamido. The size exclusion media should be selected to exclude the proteins/peptides targeted for separation so that the smaller elution solvent molecules will have a higher residence time in the media pores (compared to proteins/peptides that are totally excluded) such that the gradient elution solvent concentration, relative to the protein/peptide positions, is repositioned by each size exclusion chromatography media section prior to the protein/peptide flow into the next adsorption chromatography media section.

$$\begin{matrix}t = {t}_{0} + {K}_{sec} ( {t}_{t} - {t}_{0} ) & Equation 2 h \\ t = 60 ( \frac{z {∈}_{void}}{v} + {K}_{sec} [ \frac{z}{v} - \frac{z {∈}_{void}}{v} ] ) & Equation 2 j\end{matrix}$$

t=time (mins)
t₀=retention time for totally excluded species (mins)
tₜ=retention time for mobile phase (mins)

$$v = mobile phase superficial velocity in \frac{cm}{hr}$$

$$( flowrate \div column cross sectional A )$$

∈_{void}=column solid phase void fraction=0.35 for example scenario
K_{sec}=void fraction of the solid phase in which the large solutes of interest can access
K_{sec}=0.0 for example scenario
(K_{sec} can be optimized to exclude the larger size solute of interest)
z=column length

The linear Expression for 2-dimensional (time and column axial distance) linear elution gradient used for the reverse phase column applies to the SEC column. The total void fraction will have a different value because SEC media typically are designed with a large void fraction compared to adsorptive media. The derivation of Equation 2g is similar to the derivation described in paragraph [0025] of this specification.

$$∅ = {a}_{0} + {\frac{v}{60 {∈}_{Tsec}} [ \frac{Δ a}{Δ x} ]}_{SEC} t + {[ \frac{Δ a}{Δ x} ]}_{SEC} x \qquad Equation 2 g$$

ø=fractional solvent concentration
a₀=initial solvent concentration from previous RPC column
x=axial distance down the column length (cm)
t=time (mins)

$$v = mobile phase superficial velocity in \frac{cm}{hr}$$

$$( flowrate \div column cross sectional A )$$

∈_{Tsec}=column total void fraction=0.95 for example scenario

$${[ \frac{Δ a}{Δ x} ]}_{SEC} = SEC column solvent gradient slope$$

(change in organic solvent conc. per cm of column axial distance)

Note that the gradient slope (in units of change in organic solvent concentration per cm of axial distance) for the size exclusion column will be different than for the reverse phase column because the total void fraction for the size exclusion column is different than the total void fraction for the reverse phase column. The gradient slope for the size exclusion column can be determined from the reverse phase column slope using the void fraction ratio for each column per equation 2k:

$${[ \frac{Δ a}{Δ x} ]}_{SEC} = {[ \frac{{∈}_{Trpc}}{{∈}_{Tsec}} ] [ \frac{Δ a}{Δ x} ]}_{RPC} \qquad Equation 2 k$$

The support for the separation of two peptides/proteins using more than one pair of alternating adsorption and size exclusion chromatography medias can be accomplished using the equations provided in this specification. A numerical computational method is used to determine the elution time of each solute of interest. Equations 2g, 2f, and 2j are used in computations to describe separation of two closely related proteins/peptides species. Each column or chromatography media section is numerically integrated with the output conditions used as initial conditions for the subsequent column or media section in the sequence. A computational sequence is used to establish a design using alternating adsorption and size exclusion chromatography medias in series. The following computational sequence of the equations defined in the specification paragraphs [0020] through [0033] is used to accomplish the numerical integration:
1. Define

$${[ \frac{Δ a}{Δ x} ]}_{RPC} ,$$

a₀, z_{rpc}, ø, c, v, ∈_{Trpc} for adsorption media section. ø and c must be defined from experimentation as described in literature; G. B. Cox, “Influence of operating parameters on the preparative gradient elution chromatography of insulins”, Journal Of Chromatography, 599 (1992) 195-203. The parameters, ø and c, for the model systems in this specification are found in current literature referenced in paragraph [0056]. Table 3 of this specification. A typical value for ∈_{Trpc} is 0.78 and 100 cm/hr is a typical superficial velocity, v. The values for

$${[ \frac{Δ a}{Δ x} ]}_{RPC} ,$$

a₀, and z_{rpc} are defined using a trail and error approach as described in paragraphs [0056] through [0061] in this specification.
2. Choose integration step time, Δt, for adsorption media section (i.e. Reverse phase).
3. Calculate displacement of peptide/protein of interest, x, and total time by: (note: start integration with x=0 and t=0)

xᵢ₊₁=xᵢ+Δx

tᵢ₊₁=tᵢ+Δt
4. Calculate solvent concentration using total time and displacement using Equation 2e in specification paragraph [0026].
5. Calculate velocity of peptide/protein of interest, using equation 2f in specification paragraph [0024].
6. Calculate differential displacement of peptide/protein of interest using:

Δx=vₐΔt=peptide velocity (integration time step)
7. Continue incremental steps in time and repeat steps 3 through 6 until the solute displacement is equal to the adsorption media section length, z.
8. Calculate adsorption media section exit gradient eluent solvent concentration relative to peptide/protein of interest using total elution time for the peptide/protein in the adsorption chromatography media section, and adsorption media section length using Equation 2g_{RPC} in specification paragraph [0026] (adsorption media section exit gradient eluent solvent concentration is the initial size exclusion media elution gradient solvent concentration a₀, for the next size exclusion chromatography media section)
9. Define

$${[ \frac{Δ a}{Δ x} ]}_{SEC} ,$$

z_{sec}, v, ∈_{void}, K_{sec}, ∈_{Tsec} for the size exclusion media section.

$${[ \frac{Δ a}{Δ x} ]}_{SEC}$$

is defined by Equation 2k in specification paragraph [0033]. ∈_{Tsec} can be experimentally determined using an industry standard pulse or transitional analysis test with salt. A typical value for ∈_{void} is 0.35. The diameter of the size exclusion media section is the same as the diameter of the adsorption media section, therefore the superficial velocity will be the same, v=100 cm/hr. A value for K_{sec} is available from size exclusion chromatography media vendors for each media based on molecular weight. Size exclusion should be selected which will total exclude the peptide/protein of interest, K_{sec}=0 (see specification paragraph [0027]) z_{sec} is determined using a trial and error approach as described in paragraphs [0056] though [0061] in this specification.
10. Calculate size exclusion media section retention time of peptide/protein of interest using equation 2j in specification paragraph [0029].
11. Calculate size exclusion media section exit gradient eluent solvent concentration relative to peptide/protein of interest using peptide/protein retention time and size exclusion media section length using Equation 2g in specification paragraph [0031] (size exclusion media section exit gradient eluent solvent concentration is the initial adsorption media elution gradient solvent concentration, a₀, for the next adsorption chromatography media section).
12. Repeat computational sequence, steps 3 to 11, for each column pair.

One operating mode of the Novel Oscillatory Chromatographic Purification System with a Positive eluent solvent Gradient Slope is illustrated herein by utilizing the one dimensional model described in paragraph [0034] utilizing equations 2g, 2f and 2j.

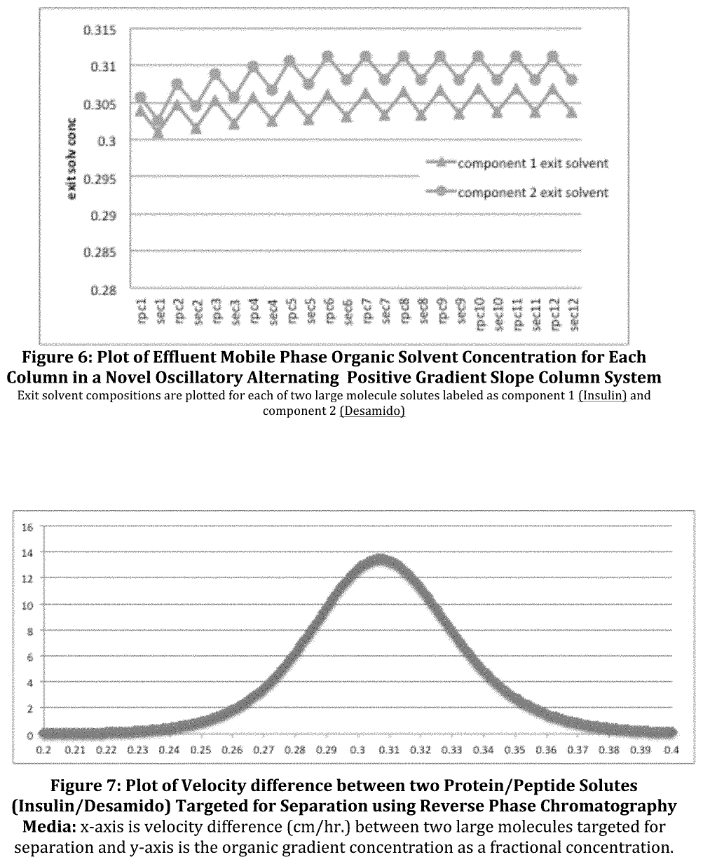

The novel multimodal chromatography in an oscillating series utilizes the alternating solvent exchange media to reposition the solvent gradient active region of separation back in phase with the target solute (Insulin/Desamido) as shown in FIG. 6. FIG. 6 shows solvent concentration in contact with each of the two proteins/peptides of interest (Insulin/Desamido) at the exit of each alternating media section. The 12 sections of reverse phase media followed by size exclusion media produces a saw blade affect as the solvent concentration associated with each of two proteins/peptides in the separation process decreases after each size exclusion media section. The novel oscillatory system is specifically designed to reposition the gradient with respect to the solute positions to move the solutes back into the region of active separation. Each solvent exchange column bed length in the sequence is designed to achieve a subtle decrease in the solvent concentration associated with the two solutes of interest which results in an extension of the active separation. An SEC column length of 6 cm for the first size exclusion column (labeled as “sec 1” in FIG. 6) shifts the relative position of the organic solvent gradient concentration with respect to the solutes of interest down by approximately 0.4% organic solvent concentration out of the 1^{st} reverse phase column prior to the 2^{nd} reverse phase column. The remaining 11 solvent exchange columns used in the scenario to generate FIG. 6 continue to reposition the gradient concentration with respect to the solutes of interest after each reversed phase column in order to achieve continued separation of the solutes of interest. The series of alternating columns reaches a pseudo-steady-state oscillation of solvent concentration if the column lengths and gradient slope are set to the conditions described by Table 1 (adsorption chromatography media sections length=4 cm; size exclusion chromatography media sections length=6 cm; elution gradient solvent slope=0.001 solvent conc. change/cm of adsorption col. length; initial elution gradient solvent conc.=0.3).

Table 1 provides the Novel Oscillatory Alternating Column design parameters and theoretical results for the specific model system used in the scenario to generate FIG. 6. Table 1 provides a positive eluent solvent concentration gradient slope design for Novel Oscillatory Alternating Chromatography System (results from the mathematical computation of a separation of two peptides. Insulin and Desamido, using more than one pair of alternating adsorption, specifically reverse phase chromatography, and size exclusion medias in series with a positive slope eluent solvent gradient). The novel system improves the separation performance of the standard one column reverse phase system. The novel system using an oscillatory sequence of twelve column pairs increases the separation time from 0.8 minutes with a single media section to 2.54 minutes with the 12 media pairs.

Design parameters for the Novel Oscillatory Chromatography system include gradient slope, bed depth of each adsorptive (rev. ph.) column, bed depth of each solvent exchange column, and gradient start concentration and are listed in Table 1.

TABLE 1
Novel Oscillatory Column Design Configuration and Theoretical
1-Dimensional Performance with Positive Gradient Slope

| | | | | | | | grad slope 0.001 | |
|---|---|---|---|---|---|---|---|---|
| | | | | | | | grad start 0.3 | |
| | component 1 | | | component 2 | | | | retention |
| | Ret. | sum rpc | | Ret. | sum rpc | | | time diff. |
| | Time | time | exit | Time | time | exit | Z | btwn |
| | (mins) | (mins) | solvent | (mins) | (mins) | solvent | (cm) | solutes |
| rpc1 | 3.75 | 3.75 | 0.3040 | 4.55 | 4.55 | 0.3057 | 4 | 0.80 |
| sec1 | 1.26 | 5.01 | 0.3009 | 1.26 | 5.81 | 0.3026 | 6 | 0.00 |
| rpc2 | 3.64 | 8.65 | 0.3047 | 4.18 | 9.99 | 0.3075 | 4 | 0.54 |
| sec2 | 1.26 | 9.91 | 0.3016 | 1.26 | 11.25 | 0.3044 | 6 | 0.00 |
| rpc3 | 3.58 | 13.49 | 0.3052 | 3.96 | 15.21 | 0.3089 | 4 | 0.38 |
| sec3 | 1.26 | 14.75 | 0.3021 | 1.26 | 16.47 | 0.3058 | 6 | 0.00 |
| rpc4 | 3.52 | 18.27 | 0.3056 | 3.80 | 20.27 | 0.3099 | 4 | 0.28 |
| sec4 | 1.26 | 19.53 | 0.3025 | 1.26 | 21.53 | 0.3068 | 6 | 0.00 |
| rpc5 | 3.48 | 23.01 | 0.3060 | 3.68 | 25.21 | 0.3107 | 4 | 0.20 |
| sec5 | 1.26 | 24.27 | 0.3028 | 1.26 | 26.47 | 0.3075 | 6 | 0.00 |
| rpc6 | 3.44 | 27.71 | 0.3062 | 3.60 | 30.07 | 0.3112 | 4 | 0.16 |
| sec6 | 1.26 | 28.97 | 0.3031 | 1.26 | 31.33 | 0.3081 | 6 | 0.00 |
| rpc7 | 3.42 | 32.39 | 0.3064 | 3.60 | 34.93 | 0.3112 | 4 | 0.18 |
| sec7 | 1.26 | 33.65 | 0.3033 | 1.26 | 36.19 | 0.3081 | 6 | 0.00 |
| rpc8 | 3.40 | 37.05 | 0.3065 | 3.60 | 39.79 | 0.3112 | 4 | 0.20 |
| sec8 | 1.26 | 38.31 | 0.3034 | 1.26 | 41.05 | 0.3081 | 6 | 0.00 |
| rpc9 | 3.40 | 41.71 | 0.3067 | 3.60 | 44.65 | 0.3112 | 4 | 0.20 |
| sec9 | 1.26 | 42.97 | 0.3036 | 1.26 | 45.91 | 0.3081 | 6 | 0.00 |
| rpc10 | 3.38 | 46.35 | 0.3068 | 3.60 | 49.51 | 0.3112 | 4 | 0.22 |
| sec10 | 1.26 | 47.61 | 0.3037 | 1.26 | 50.77 | 0.3081 | 6 | 0.00 |
| rpc11 | 3.36 | 50.97 | 0.3069 | 3.60 | 54.37 | 0.3112 | 4 | 0.24 |
| sec11 | 1.26 | 52.23 | 0.3038 | 1.26 | 55.63 | 0.3081 | 6 | 0.00 |
| rpc12 | 3.36 | 55.59 | 0.3069 | 3.60 | 59.23 | 0.3112 | 4 | 0.24 |
| sec12 | 1.26 | 56.85 | 0.3038 | 1.26 | 60.49 | 0.3081 | 6 | 0.00 |

The novel alternating column system can be designed for any number of column pairs. This example utilizes 12 media section pairs or 12 column pairs. The media section pairs will be referred to as column pairs with the caveat that the novel alternating media hardware may be designed as media sections in a single column, or separate columns for each media. The column lengths or media section lengths are identical in each pair, thus allowing a looped configuration where the feed solution is injected into the system and recycled through a loop configuration that could be recycled 12 times through a single column pair, or 6 times through a double column pair (2 RPC and 2 SEC columns) to achieve the same results as a once-through 12 column pair system.

Note in the Table 1 list of parameters, the starting organic solvent concentration of the gradient is 0.30 or 30%. This is the organic solvent concentration that provides the largest difference in the proteins/peptides solute velocities of the two solutes of interest (Insulin/Desamido) in the separation scheme. A plot of the velocity difference in solutes of interest (Insulin and Desamido) verses organic solvent concentration in the RPC media is shown in FIG. 7. Equation 2f was used to calculate the theoretical velocity for the two solutes of interest for multiple organic solvent concentrations to generate FIG. 7. The velocity difference is greatest at an organic concentration of 30%. That is rationale for choosing the initial condition so that the system operates close to the maximum velocity difference or maximum separation potential at the 30% organic solvent concentration.

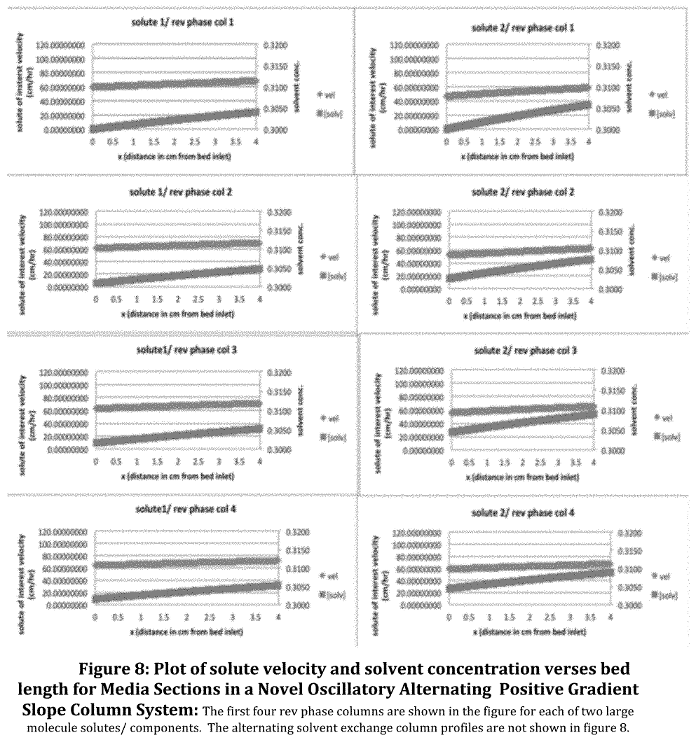

FIG. 8 shows the velocity profile for each of two closely related solutes (named Solute1 and Solute 2) of interest in each of four initial sequential reverse phase columns with gradient elution. The last 8 reverse phase columns associated with the scenario depicted in FIG. 6 and Table 1 are not included in FIG. 8 because the system approaches steady-state after the 4th column pair, therefore subsequent reverse phase column profiles would look similar to the 4th column profile. The velocity profiles are plotted as solute velocity verse column length. Plots for the solvent exchange columns between each of the sequential reverse phase columns are not included in FIG. 8. The strategy of the novel oscillatory system is to reposition the gradient position with respect to the protein/peptide solute positions so as to keep the protein/peptide solutes in the region of the most active separation.

In the example presented here, the cycle of sequential columns does not extend beyond 12 cycles. If the sequence of columns is established as a repeatable configuration, the system could be design as a loop with an injection port and the system could be recycled until the desired separation is achieved.

A second operating mode of the Novel Oscillatory Chromatographic Purification System with a Negative Eluent Solvent Gradient Slope is illustrated herein by again utilizing the one dimensional model per the previous description utilizing equations 2g, 2f and 2j. The negative slope for the eluent solvent gradient is considered as the best design for the novel multimodal chromatography system.

Alternatively to the positive gradient slope design, the novel oscillatory chromatography configuration can be designed to accommodate a negative slope gradient. The negative gradient slope design produces an acceleration in the differential migration rate of the two solutes of interest.

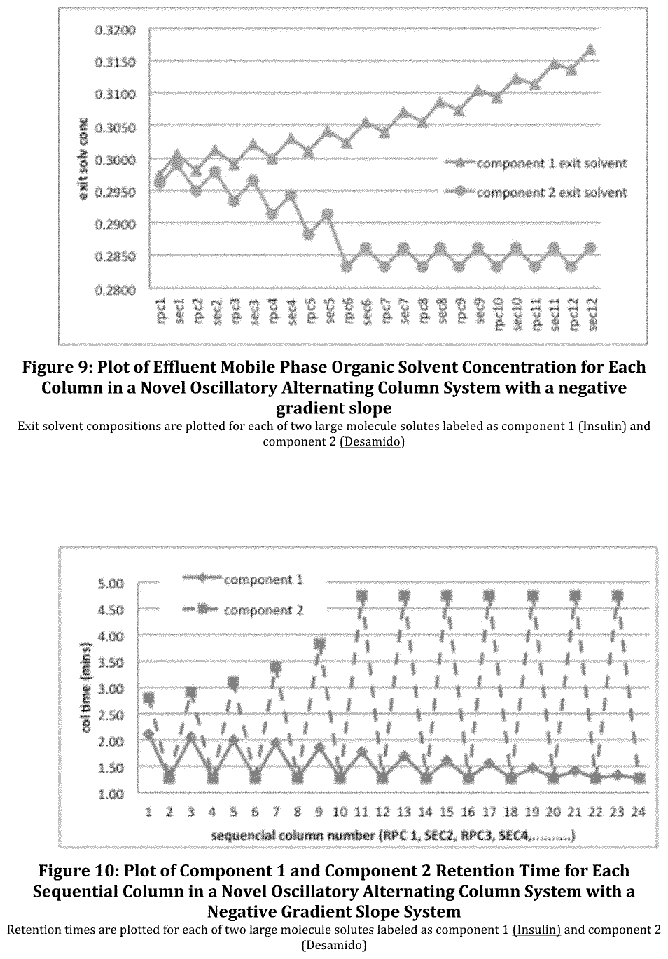

The novel multimodal chromatography in an oscillating series utilizes the alternating solvent exchange media to reposition the active region of separation back in phase with the faster moving solute of interest, component 1, while the slower moving solute of interest, component 2, is exposed to a decreasing organic solvent concentration as shown in FIG. 9. The novel oscillatory system is specifically designed, as described in paragraphs [0056] through [0062] of this specification, to reposition the gradient with respect to the solute positions to produce an increasing difference in the retention time between the two solutes of interest (again using the Insulin/Desamido separation) as shown in FIG. 10. Each solvent exchange column bed length in the sequence is designed to achieve a subtle increase in the solvent concentration for component 1 and a continual decrease in the solvent concentration associated with component 2 which results in an acceleration of the active separation.

An SEC column length for the first size exclusion column (labeled sec 1 in FIG. 9) of 6 cm shifts the relative position of the organic solvent gradient concentration with respect to the component 1 (Insulin) and component 2 (Desamido) in opposite directions which results in substantial enhancement of the separation between the two components or solutes of interest. The remaining 11 solvent exchange columns used in the scenario to generate FIG. 6 continue to reposition the gradient concentration with respect to the solutes of interest after each reversed phase column in order to achieve continued separation of the solutes of interest as shown in FIG. 10.

FIG. 10 provides a plot of retention time in each column (including both SEC and RPC columns). Note that a difference in retention time between the two components or solutes of interest (Insulin and Desamido) occur only in the reverse phase columns. The alternating SEC columns have the same retention time for both components.

The series of alternating columns produces an ever increasing difference in solvent concentration associated with each component or solute of interest if the column lengths and gradient slope are set to the conditions described by Table 2 (adsorption chromatography media sections length=2 cm: size exclusion chromatography media sections length=6 cm; elution gradient solvent slope=−0.001 solvent conc. change/cm of adsorption col. length; initial elution gradient solvent conc.=0.3).

Table 2 provides the Novel Oscillatory Alternating Column design parameters and theoretical results for the specific model system used in the scenario to generate FIGS. 9 and 10. The novel system improves the separation performance of the standard one column reverse phase system. The difference in retention time between the two components (solutes of interest) for each column is shown in table 2. The sum of the differences in retention time or the cumulative difference in retention times for the two components is 12.07 minutes. The novel system using an oscillatory sequence of twelve column pairs increases the separation time from 0.69 minutes with a single column to 12.07 minutes with the 12 column pair.

Design parameters for the Novel Oscillatory Alternating Column system include gradient slope, bed depth of each adsorptive (rev. ph.) column, bed depth of each solvent exchange column, and gradient start concentration and are listed in Table 2.

TABLE 2
Novel Oscillatory Column Design Configuration and Theoretical
1-Dimensional Performance with Negative Gradient Slope

| | | | | | | | grad slope −0.001 | |
|---|---|---|---|---|---|---|---|---|
| | | | | | | | grad start 0.3 | |
| | component 1 | | | component 2 | | | | retention |
| | Ret. | sum rpc | | Ret. | sum rpc | | | time diff. |
| | Time | time | exit | Time | time | exit | Z | btwn |
| | (mins) | (mins) | solvent | (mins) | (mins) | solvent | (cm) | solutes |
| rpc1 | 2.11 | 2.11 | 0.2975 | 2.80 | 2.80 | 0.2960 | 2 | 0.69 |
| sec1 | 1.26 | 3.37 | 0.3006 | 1.26 | 4.06 | 0.2991 | 6 | 0.00 |
| rpc2 | 2.06 | 5.43 | 0.2982 | 2.92 | 6.98 | 0.2949 | 2 | 0.86 |
| sec2 | 1.26 | 6.69 | 0.3013 | 1.26 | 8.24 | 0.2980 | 6 | 0.00 |
| rpc3 | 2 | 8.69 | 0.2990 | 3.10 | 11.34 | 0.2934 | 2 | 1.10 |
| sec3 | 1.26 | 9.95 | 0.3022 | 1.26 | 12.60 | 0.2965 | 6 | 0.00 |
| rpc4 | 1.94 | 11.89 | 0.3000 | 3.38 | 15.98 | 0.2913 | 2 | 1.44 |
| sec4 | 1.26 | 13.15 | 0.3031 | 1.26 | 17.24 | 0.2944 | 6 | 0.00 |
| rpc5 | 1.86 | 15.01 | 0.3011 | 3.84 | 21.08 | 0.2882 | 2 | 1.98 |
| sec5 | 1.26 | 16.27 | 0.3043 | 1.26 | 22.34 | 0.2913 | 6 | 0.00 |
| rpc6 | 1.78 | 18.05 | 0.3024 | 4.74 | 27.08 | 0.2832 | 2 | 2.96 |
| sec6 | 1.26 | 19.31 | 0.3056 | 1.26 | 28.34 | 0.2863 | 6 | 0.00 |
| rpc7 | 1.70 | 21.01 | 0.3039 | 4.74 | 33.08 | 0.2832 | 2 | 3.04 |
| sec7 | 1.26 | 22.27 | 0.3070 | 1.26 | 34.34 | 0.2863 | 6 | 0.00 |
| rpc8 | 1.62 | 23.89 | 0.3056 | 4.74 | 39.08 | 0.2832 | 2 | 3.12 |
| sec8 | 1.26 | 25.15 | 0.3087 | 1.26 | 40.34 | 0.2863 | 6 | 0.00 |
| rpc9 | 1.56 | 26.71 | 0.3074 | 4.74 | 45.08 | 0.2832 | 2 | 3.18 |
| sec9 | 1.26 | 27.97 | 0.3105 | 1.26 | 46.34 | 0.2863 | 6 | 0.00 |
| rpc10 | 1.48 | 29.45 | 0.3093 | 4.74 | 51.08 | 0.2832 | 2 | 3.26 |
| sec10 | 1.26 | 30.71 | 0.3124 | 1.26 | 52.34 | 0.2863 | 6 | 0.00 |
| rpc11 | 1.40 | 32.11 | 0.3114 | 4.74 | 57.08 | 0.2832 | 2 | 3.34 |
| sec11 | 1.26 | 33.37 | 0.3145 | 1.26 | 58.34 | 0.2863 | 6 | 0.00 |
| rpc12 | 1.34 | 34.71 | 0.3137 | 4.74 | 63.08 | 0.2832 | 2 | 3.40 |
| sec12 | 1.26 | 35.97 | 0.3168 | 1.26 | 64.34 | 0.2863 | 6 | 0.00 |

Claim 1 of this invention, comprising more than one pair of alternating adsorption and size exclusion media in series, is supported by paragraph [0038] Table 1 and paragraph [0049], Table 2 in this specification. Paragraph [0049]. Table 2 provides the results from the mathematical computation of a separation of two peptides using more than one pair of alternating adsorption, specifically reverse phase chromatography, and size exclusion medias in series with a negative slope eluent solvent gradient. The first column of paragraph [0049], Table 2 describes 12 pairs of alternating reverse phase columns, labeled as rpc1, rpc2, . . . , rpc12, and size exclusion columns, labeled as sec1, sec2, . . . , sec12, linked in a 12 pair sequence of alternating adsorption and size exclusion media in series which provides explicit support for the claimed invention comprising more than one pair of alternating adsorption and size exclusion media in series. Claim 3 extends the invention to include the positive slope case. Paragraph [0038]. Table 1 supports the positive solvent gradient elution slope operation of the invention in a similar manner as described herein for Table 2.

Each row in Table 2 provides the mathematical model results for the “retention time” and exit gradient elution solvent concentration with respect to each of two peptides for the negative solvent gradient elution case. The exit gradient elution solvent concentration is labeled as “exit solvent” in Table 2, paragraph [0049] of this specification. The two peptides to be separated are identified in Table 2 as component 1 (Insulin) and component 2 (Desamido), described by paragraph [0045] in this specification. In a similar manner, paragraph [0038]. Table 1 in the specification provides the same information for the positive slope solvent gradient elution case.

Claim 1 support in this specification for the gradient elution solvent concentration being increased in each size exclusion media section for the negative slope eluent solvent gradient case is depicted in Table 2. The gradient elution solvent concentration listed in specification paragraph [0049], Table 2 “exit solvent” under component 1 shows the 1^{st} adsorption media section, “rpc1”, exit solvent concentration of 0.2975. Table 2 “exit solvent” under component 1 shows the 1^{st} size exclusion media section. “sec1”, exit solvent concentration of 0.3006. These results from the mathematical model demonstrate that the size exclusion media section, “sec1”, increases the gradient elution solvent concentration relative to the peptide, component 1 (Insulin), from 0.2975 out of the 1^{st} adsorption media to 0.3006 out of the 1^{st} size exclusion. The increase of the gradient elution solvent concentration relative to the peptide, component 1 (Insulin), continues for each adsorption-size exclusion media pair for both component 1 (Insulin) and component 2 (Desamido) in “exit solvent” columns of Table 2. Additionally, FIG. 9 in the specification drawings demonstrates the increase of the gradient elution solvent concentration relative to the peptide, component 1, continues for each adsorption-size exclusion media pair for both component 1 and component 2 by the saw-tooth shaped plot for gradient elution solvent concentration. In a similar manner, paragraph [0038] Table 1 and FIG. 6 in this specification and the drawings support the positive solvent gradient elution slope operation of the invention for the gradient elution concentration (being) decreased in each size exclusion media section. Additionally. Table 2 and FIG. 9, and Table 1 and FIG. 6 in this specification provide support in regard to claim 1 for the continued repositions of the gradient elution concentration with respect to the protein/peptide.

Claim 1 support in this specification for a gradient elution solvent concentration that is increased relative to the protein/peptide positions back into an eluent gradient concentration where the protein/peptides to be separated continue to migrate at different velocities in the next adsorption media section is demonstrated in Table 2 for the negative slope gradient case. The mathematical computation for retention time for component 1 listed in Table 2, “Ret. time (mins)” column, under component 1 shows the 1st adsorption media section, row “rpc1”, retention time of 2.11 minutes. The retention time for component 2 listed in Table 2. “Ret. time (mins)”, column under component 2 shows the 1^{st} adsorption media section, row “rpc1”, retention time of 2.80 minutes. The difference in the retention times for the two peptides, component 1 and component 2, is inherent to peptides to be separated migrating at different velocities in the adsorption media section. The difference in retention time is mathematically understood as a difference in migration velocity of the two peptides and is captured in Table 2 as the “retention time diff. between solutes” column. The retention time for component 1 listed in Table 2, “Ret. time (mins)” column, under component 1 shows the 2nd adsorption media section, row “rpc2”, retention time of 2.06 minutes. The retention time for component 2 listed in Table 2 “Ret. time (mins)” column, under component 2 shows the 2nd adsorption media section, row “rpc2”, retention time of 2.92 minutes. The difference in the retention times, mathematically understood as a difference in migration velocity of the two peptides, component 1 and component 2, continues to show a difference of 0.86 minutes in the “rpc2” row, a difference of 1.10 minutes in the “rpc3” row, a difference of 1.44 minutes in the “rpc4” row, and continues to increase in time in each “rpc” row. This trend is inherent to peptides to be separated migrating at different velocities in the next adsorption media section. These results from the mathematical model demonstrate that the protein/peptides to be separated continue to migrate at different velocities in the next adsorption media section. Additionally, FIG. 10, a plot of the mathematical results for retention time in the specification drawings demonstrates that the difference of the retention times inherent to different migration velocities for peptides, component 1 and component 2, continues for each adsorption media by the difference in the maximum peak heights of component 1 and 2 saw-tooth shaped plot for retention time. Claim 3 extends the invention to include the positive slope case. In a similar manner, paragraph [0038] Table 1 and FIG. 7 in this specification and the drawings support the positive solvent gradient elution slope operation of the invention for the protein/peptides to be separated continue to migrate at different velocities in the next adsorption media section.

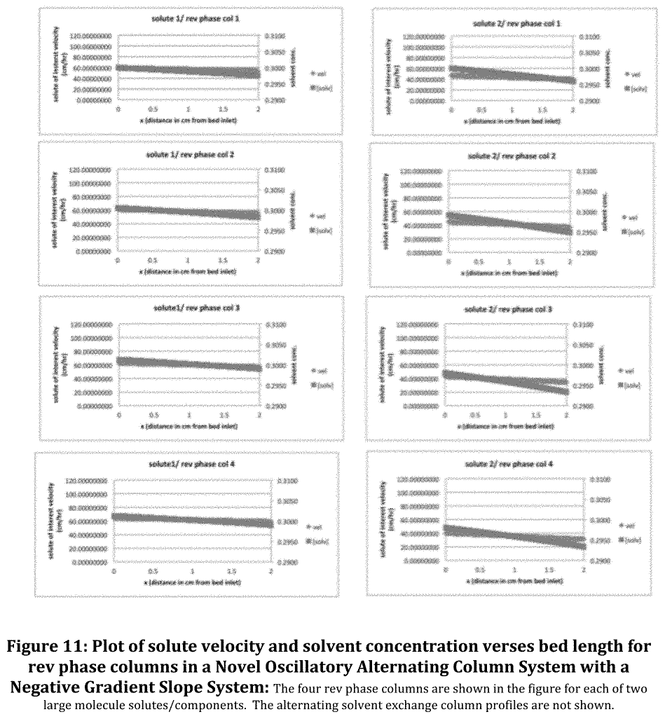

FIG. 11 shows the velocity profile for each of two closely related components or solutes (named Solute1=Insulin and Solute 2=Desamido) of interest in each of four initial sequential reverse phase columns with gradient elution. The last 8 reverse phase columns associated with the scenario depicted in FIG. 9, FIG. 10, and Table 1 are not included in FIG. 11. The system approaches a pseudo-steady state and continues to increase in separation time between the two solutes or components of interest. The velocity profiles are plotted as solute velocity verse column length. Plots for the solvent exchange columns between each of the sequential reverse phase columns are not included in FIG. 11. The strategy of the novel oscillatory system is to reposition the gradient position with respect to the solute positions so as to keep the solutes in the region of the most active separation.

In the example presented here, the cycle of sequential columns does not extend beyond 12 cycles. If the sequence of columns is established as a repeatable configuration, the system could be design as a loop with an injection port and the system could be recycled until the desired separation is achieved.

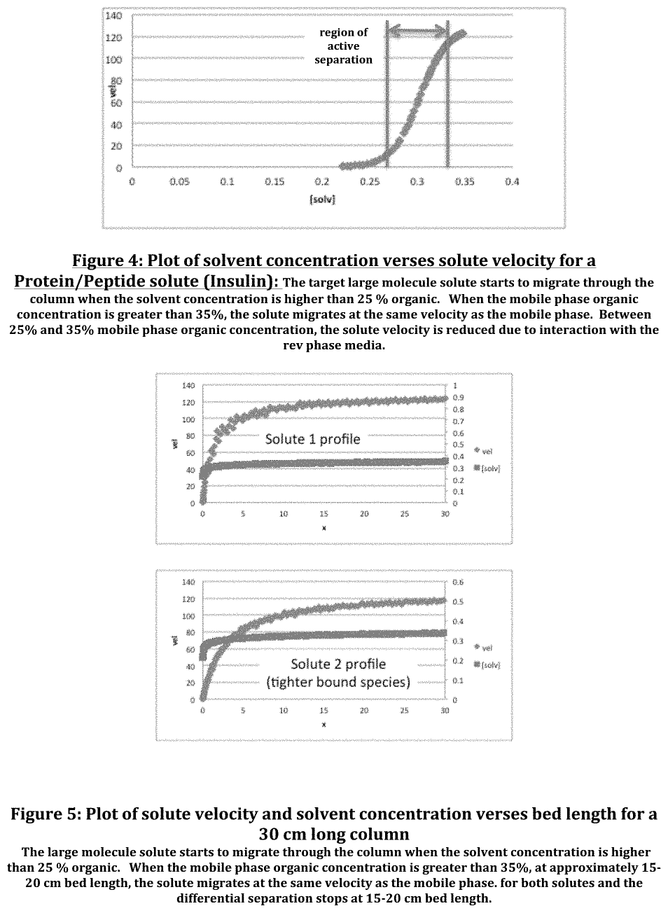

The theoretical design for the Novel Oscillating Chromatography System has been applied to the peptide/protein separations listed in Table 3. Best operating conditions for each system have been successfully determined through a trial and error computational approach described in this specification. Tables 1 and 2 in this specification and Drawing Submittal FIGS. 4 through 11 were generated for Insulin and Desamido as the two proteins/peptides to be separated. Tables 4 and 5 in this specification and Drawing Submittal FIGS. 12 and 13 were generated for Porcine Insulin and Desamido (MW=6000 Daltons) as the two proteins/peptides to be separated. Similarly, best operating conditions for each system have been successfully determined for the ribonucleaseA and lysosome (MW=12,500 and 14,000 Daltons). The values for the parameters. S and Ko, in equations 2c, 2d, and 2f were determined from the referenced literature articles listed in Table 3 for the proteins/peptides to be separated listed in Table 3. The method for empirical determination of the parameters. S and Ko, can be found in reference literature publication by M. A. Quarry, R. L. Grob and L. R. Snyder, Anal. Chem., 58 (1986) 907.

TABLE 3
Proteins/Peptides used for the Novel Oscillatory Column Model Spreadsheet Assessment

| | | | | | organic | |
|---|---|---|---|---|---|---|
| proteins/peptides | | | | | solvent/ | |
| targeted for | S | S | Ko | Ko | chrom. | |
| separation | (product) | (impurity) | (product) | (impurity) | Media | reference literature |
| Porcine insulin- | −15.23 | −14.92 | 5.48 | 5.45 | Acetonitrile | G.B. Cox, “Influence of operating parameters |
| Desamido | | | | | | on the preparative gradient elution chromatography |
| | | | | | | of insulins”, Journal Of Chromataography, |
| | | | | | | 599 (1992) 195-203 |
| Insulin-Desamido | −29.898 | −29.124 | 9.034 | 8.98 | Acetonitrile/ | |
| | | | | | C8 silica | |
| RibonucleasA- | −41.3 | −39.2 | 12.3 | 15.4 | Acetonitrile/ | M.A. Stadalius et.al., “Optimization Model for the |
| Lysozyme | | | | | C8 silica | gradient separation of peptide mixtures by reverse |
| | | | | | | phase high performance liquid chromatography”, |
| | | | | | | Journal Of Chromataography, 296 (1984) 31-59 |

The process to determine the best design of the Multimodal Oscillatory Chromatography System is described herein using a Porcine Insulin and Desamido example. The approach to designing the specific size exclusion column (or media) length, adsorption column (or media) length, gradient slope, and starting radiant concentration for the Novel Oscillating Chromatography System is described herein. Negative slope solvent gradient elution is the better operational mode for the multimodal oscillatory chromatography system as compared to a positive slope solvent gradient elution. The negative slope elution produces a larger cumulative separation of the two proteins/peptides to be separated. The design is multivariate with size exclusion column lengths, adsorption column lengths, gradient slope, and initial (starting) gradient solvent concentration. The process to determine the best design of the multimodal oscillatory chromatography system is a trial and error process. A spread sheet model utilizing the computational scheme in paragraph [0034] is used to evaluate the variables or operating conditions (column lengths, eluent solvent gradient slope and starting concentration) using a trial and error approach. Two criteria are used to determine the best operating conditions; a pseudo-steady state saw-tooth oscillation for the elution gradient solvent concentration similar to FIG. 9 resulting in a steady-state retention time for the more retained protein/peptide (component 2 in FIG. 10): and maximizing the cumulative retention time difference between the two proteins/peptide solutes targeted for separation. The best operating conditions produce a pseudo-steady state for the elution gradient solvent concentration similar to the pattern in FIG. 9 in the drawings submittal. Additionally, the best operating conditions maximize the cumulative retention time difference between the two proteins/peptide solutes targeted for separation. A systematic approach to the trail and error search for the best column lengths and gradient conditions utilizing a spread sheet model of the computational scheme in paragraph [0034] is described herein:

An adsorption column length of 2 cm to 7 cm will produce a pseudo-steady state saw-tooth oscillation for the elution gradient solvent concentration similar to FIG. 9 if paired with sufficiently long size exclusion column length. With a negative slope solvent elution gradient, the size exclusion column must be long enough to increase the gradient elution solvent concentration sufficiently, relative to the protein/peptide positions, prior to the protein/peptide flow into the next adsorption chromatography media section so that the proteins/peptides targeted for separation do not get stuck in the adsorption column. It is commonly understood, specific to the particular protein/peptide, that if the elution solvent concentration is too low, the protein/peptide will not elute from an adsorption column (it is completely adsorbed by the media/“stuck” in the column). Adsorption column lengths greater that 7 cm will result in size exclusion column lengths that are impractically long. Additionally for a particular adsorption column length selected for the trial and error computation, the same column length is used for each of the adsorption columns in the novel oscillating chromatography system. For a particular size exclusion column length selected for the trial and error computation, the same column length is used for each of the size exclusion columns in the Novel Oscillating Chromatography System. The computation is based on 12 column pairs of adsorption/size exclusion chromatography media pairs. The 12 pair design is arbitrarily selected to keep the system design simple for the trial and error computation and to observe the model behavior with multiple adsorption/size exclusion media pairs.

As adsorption columns or media section lengths increase, the size exclusion chromatography columns or media lengths must be increased to achieve pseudo-steady state. If the size exclusion column/media lengths are not increased sufficiently, the outlet solvent concentration of the size exclusion column goes too low in the column sequence and proteins/peptide solutes targeted for separation get stuck or retained in the adsorption column. Additional increase in the size exclusion chromatography length greater than the minimum length to reach pseudo-steady state results in a lower cumulative retention time difference between the two proteins/peptide solutes targeted for separation. Therefore, the optimal size exclusion chromatography length for a given adsorption length is the minimum size exclusion chromatography length needed to produce the pseudo-steady state. So the trial and error design strategy is to start with a 2 cm adsorption column and incrementally increase the adsorption column length followed by an increase in the size exclusion chromatography length. Determination of the size exclusion column length follows the strategy of trial and error, starting at a small size exclusion chromatography length of 2 cm and increasing the size exclusion chromatography length until the operating conditions produce a pseudo-steady state for the elution gradient solvent concentration similar to the pattern in FIG. 9 in the drawings submittal.

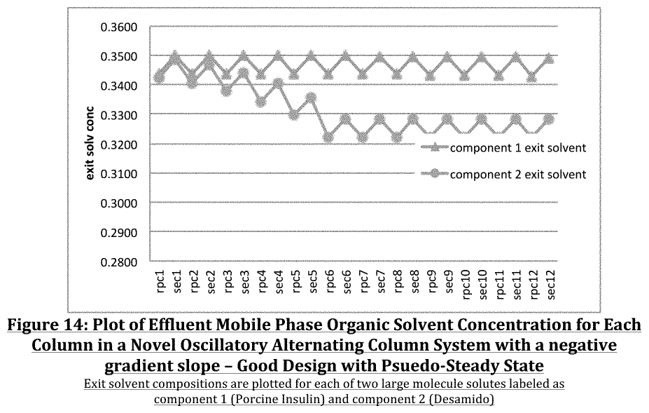

A summary of the trial and error approach to determine the best adsorption columns length and the best size exclusion columns length is listed in Table 4 for a Porcine insulin—Desamido model for which a spread sheet model of the computational scheme in paragraph [0034] of this specification was used to evaluate the variables or operating conditions (column lengths). Table 4 results from several trail and error designs show that, as the adsorption columns length increases, the corresponding size exclusion columns length in the column pair must increase to prevent complete adsorption of one of the protein/peptides of interest targeted for separation. Three designs are presented in Table 4 for each adsorption columns/medias length of 2, 3, 4, and 7 cm. The three designs for each adsorption columns/medias length show the size exclusion column length that is too short to maintain the eluent gradient solvent concentration at a high enough concentration to keep one of the protein/peptides of interest from sticking to the adsorption column and two additional size exclusion column lengths that produce a pseudo-steady state design. FIG. 13 in the drawings submittal shows the saw-tooth oscillation profile for the elution gradient solvent concentration for Table 4 1st row of operating conditions (2 cm adsorption column length/5 cm size exclusion column length design). FIG. 13 illustrates the column exit solvent concentration profile that is not a desirable design because it is not a pseudo-steady state pattern. FIG. 14 in the drawings submittal shows the saw-tooth oscillation profile for the elution gradient solvent concentration for Table 4, 2nd row of operating conditions (2 cm adsorption column length/6 cm size exclusion column length design). FIG. 14 illustrates the desired pseudo-steady state design. Additionally, as the size exclusion column length is increased above the minimum length needed to produce a pseudo-steady state saw-tooth profile for the elution gradient solvent concentration, the cumulative retention time difference between the two proteins/peptide solutes targeted for separation decreases in all cases in Table 4. The best size exclusion column length for a given adsorption column length is the minimum length to produce a pseudo-steady state saw-tooth profile for the elution gradient solvent concentration. The 2^{nd} row (2 cm adsorption chromatography media length/6 cm size exclusion chromatography media length) and 5th row (3 cm adsorption chromatography media length/11 cm size exclusion chromatography media length) of the design criteria's in the Table 4 spreadsheet assessment are the best designs because they have lower total process time than the 4 cm or 7 cm adsorption chromatography media length designs.

TABLE 4
Novel Oscillatory Column Model Spreadsheet Assessment of Various Operating Conditions with
Negative Solvent Gradient Slope
Porcine-Desamido Peptide Separation

| | | | | | elution solvent | |
|---|---|---|---|---|---|---|
| | | | cummulative retention | | gradient slope | |
| | Size | | time difference | Total | (change in organic | |
| Adsorption | Exclusion | | (total minutes between | process | solvent conc. per | elution solvent |
| Column | Column | Elution gradient solvent | insulin and desamido | time | cm of column | gradient start |
| Length | Length | saw-tooth profile | after 7 col pairs) | (mins) | axial distance) | concentration |
| 2 | 5 | porcine isnsulin gets | N/A-system design | | −0.002 | 0.35 |
| | | stuck in system | does not work | | | |
| 2 | 6 | psuedo-steady state | 6.81 | 60 | −0.002 | 0.35 |
| 2 | 7 | psuedo-steady state | 4.87 | | −0.002 | 0.35 |
| 3 | 10 | desamido gets stuck in | N/A-system design | | −0.002 | 0.35 |
| | | system | does not work | | | |
| 3 | 11 | psuedo-steady state | 18.7 | 108 | −0.002 | 0.35 |
| 3 | 12 | psuedo-steady state | 9.79 | | −0.002 | 0.35 |
| 4 | 16 | desamido gets stuck in | N/A-system design | | −0.002 | 0.35 |
| | | system | does not work | | | |
| 4 | 17 | psuedo-steady state | 32.47 | 160 | −0.002 | 0.35 |
| 4 | 18 | psuedo-steady state | 12.97 | | −0.002 | 0.35 |
| 7 | 46 | porcine isnsulin gets | N/A-system design | | −0.002 | 0.35 |
| | | stuck in system | does not work | | | |
| 7 | 47 | psuedo-steady state | 45.7 | 230 | −0.002 | 0.35 |
| 7 | 48 | psuedo-steady state | 20.56 | | −0.002 | 0.35 |

The elution gradient solvent initial concentration that provides the best results will be close to the concentration that produces the largest velocity difference between the two protein/peptide solutes targeted for separation. Using equation 2f in this specification, the velocity for each of the two proteins/peptide solutes targeted for separation can be computed for several eluent mobile phase solvent concentrations. Then the difference between the two protein/peptide solute velocities can be computed for each eluent mobile phase solvent concentration and plotted similar to FIG. 7. A spread sheet model utilizing the computational scheme in paragraph [0034] is used to evaluate several gradient solvent initial (starting) concentrations by a trial and error approach. Two criteria are used to determine the best gradient solvent initial (starting) concentration, a pseudo-steady state for the elution gradient solvent concentration resulting in a steady-state retention time for the more retained protein/peptide (component 2 in FIG. 10) and cumulative retention time difference between the two proteins/peptide solutes targeted for separation. The best starting eluent solvent concentration produces a pseudo-steady state for the elution gradient solvent concentration similar to the pattern in FIG. 9 in the drawings submittal. Additionally, the best starting eluent solvent concentration produces he largest cumulative retention time difference between the two proteins/peptide solutes targeted for separation.

A spread sheet model utilizing the computational scheme in paragraph [0034] is used to evaluate the final variable in the design, slope of the elution solvent gradient concentration, by a trial and error approach. As the slope of the elution solvent gradient concentration increases to larger negative numbers, the size exclusion chromatography column length and elution gradient solvent initial concentration must be adjusted to achieve pseudo-steady state similar to the design assessment for increasing the adsorption chromatography media length. If the size elution gradient solvent initial concentration and size exclusion chromatography column length are not increased sufficiently, the outlet solvent concentration of the size exclusion column goes too low in the column sequence and proteins/peptide solutes targeted for separation get stuck or retained in the adsorption column. Similar to the assessment in paragraph [0060], additional increase in the size exclusion chromatography length greater than the minimum length to reach pseudo-steady state for a given elution gradient solvent initial concentration results in a lower cumulative retention time difference between the two proteins/peptide solutes targeted for separation. Therefore, the optimal size exclusion chromatography length for a given adsorption length and elution gradient solvent initial concentration is the minimum size exclusion chromatography length needed to produce the pseudo-steady state. The trial and error design strategy is to start with a −0.001 elution solvent gradient slope and incrementally increase the elution solvent gradient slope followed by an increase in the elution gradient solvent initial concentration utilizing the minimum size exclusion chromatography length that produce the pseudo-steady state.

A summary of the trial and error approach to determine the best slope of the elution solvent gradient concentration is listed in Table 5 for a Porcine Insulin—Desamido model for which a spread sheet model of the computational scheme in paragraph [0034] was used to evaluate the impact of the slope of the elution solvent gradient on the design for the novel oscillating chromatography system. Table 5 results from several trail and error designs show that, as the elution solvent gradient concentration slope increases, the starting gradient concentration must increase to prevent complete adsorption of one of the protein/peptides of interest targeted for separation. Multiple designs are presented in Table 5 for two elution solvent gradient concentration slopes, −0.005 and −0.01 which can be compared to the gradient slope of −0.002 used to generate Table 4. Several designs produce the desired pseudo-steady state saw-tooth profile for the elution gradient solvent concentration. The eluent solvent gradient slope best design, as defined by maximizing the cumulative retention time difference between the Porcine Insulin and Desamido solutes targeted for separation, is the design using the negative elution gradient solvent slope of −0.05 in Table 5, with a starting gradient concentration of 0.39, adsorption column length of 4 cm and a size exclusion length of 3 cm.

TABLE 5
Novel Oscillatory Column Model Spreadsheet Assessment of Various Operating Conditions
with Increasing Negative Solvent Gradient Slope
Porine-Desamido Peptide Separation

| | | | | | elution solvent | |
|---|---|---|---|---|---|---|
| | | | cummulative retention | | gradient slope | |
| | Size | | time difference | Total | (change in organic | |
| Adsorption | Exclusion | | (total minutes between | process | solvent conc. per | elution solvent |
| Column | Column | Elution gradient solvent | insulin and desamido | time | cm of column | gradient start |
| Length | Length | saw-tooth profile | after 7 col pairs) | (mins) | axial distance) | concentration |
| 2 | 9 | porcine isnsulin gets | N/A-system design | | −0.005 | 0.35 |
| | | stuck in system | does not work | | | |
| 2 | 10 | 11 | 6.12 | 60 | −0.005 | 0.35 |
| 2 | 11 | psuedo-steady state | 3.1 | | −0.005 | 0.35 |
| 3 | 22 | desamido gets stuck in | N/A-system design | | −0.005 | 0.35 |
| | | system | does not work | | | |
| 3 | 23 | psuedo-steady state | 12.51 | 92 | −0.005 | 0.35 |
| 3 | 24 | psuedo-steady state | 6.81 | | −0.005 | 0.35 |
| 4 | any length | porcine insulin and | N/A-system design | | −0.005 | 0.35 |
| | | desamido get stuck in | does not work | | | |
| | | system | | | | |
| 4 | 10 | psuedo-steady state | 7.3 | 63 | −0.005 | 0.37 |
| | | | (system design does not | | | |
| | | | work if size exclusion | | | |
| | | | col. Is shorter) | | | |
| 4 | 3 | psuedo-steady state | 16.26 | 87 | −0.005 | 0.39 |
| | | | (system design does not | | | |
| | | | work if size exclusion | | | |
| | | | col. Is shorter) | | | |
| 4 | 2 | psuedo-steady state | 0.81 | | −0.005 | 0.41 |
| | | | (system design does not | | | |
| | | | work if size exclusion | | | |
| | | | col. Is shorter) | | | |
| 2 | any length | porcine insulin and | N/A-system design | | −0.01 | 0.35 |
| | | desamido get stuck in | does not work | | | |
| | | system | | | | |
| 2 | 5 | psuedo-steady state | 3.39 | 31 | −0.01 | 0.37 |
| | | | (system design does not | | | |
| | | | work if size exclusion | | | |
| | | | col. Is shorter) | | | |
| 2 | 2 | psuedo-steady state | 1.26 | | −0.01 | 0.39 |
| | | | (system design does not | | | |
| | | | work if size exclusion | | | |
| | | | col. Is shorter) | | | |
| 3 | any length | porcine insulin and | N/A-system design | | −0.01 | 0.35 |
| | | desamido get stuck in | does not work | | | |
| | | system | | | | |
| 3 | 12 | psuedo-steady state | 3.39 | 53 | −0.01 | 0.37 |
| | | | (system design does not | | | |
| | | | work if size exclusion | | | |
| | | | col. Is shorter) | | | |
| 3 | 4 | psuedo-steady state | 1.07 | | −0.01 | 0.39 |
| | | | (system design does not | | | |
| | | | work if size exclusion | | | |
| | | | col. Is shorter) | | | |
| 4 | any length | porcine insulin and | N/A-system design | | −0.01 | 0.35 |
| | | desamido get stuck in | does not work | | | |
| | | system | | | | |
| 4 | any length | porcine insulin and | N/A-system design | | −0.01 | 0.37 |
| | | desamido get stuck in | does not work | | | |
| | | system | | | | |
| 4 | 5 | psuedo-steady state | 4.15 | | −0.01 | 0.39 |
| | | | (system design does not | | | |
| | | | work if size exclusion | | | |
| | | | col. Is shorter) | | | |
| 4 | 2 | psuedo-steady state | 1.34 | | −0.01 | 0.41 |
| | | | (system design does not | | | |
| | | | work if size exclusion | | | |
| | | | col. Is shorter) | | | |

A summary of the trial and error approach to determine the best designs are listed in Table 6 for Porcine Insulin/Desamido separation, Insulin/Desamido separation, and a Ribonuclease A/Lysozyme separation. The computational scheme in paragraph [0034] was used to evaluate the impact of the adsorption media length, the size exclusion media length, and the slope of the elution solvent gradient and the elution gradient solvent initial concentration on the design for the novel oscillating chromatography system. Table 6 results are the best design options from several trail and error designs for each protein/peptide separation using the novel oscillating chromatography system.

TABLE 6
Summary of the Trial And Error Approach to Determine the Best
Designs for the Novel Oscillating Chromatography System

| | | | elution | elution | organic |
|---|---|---|---|---|---|
| proteins/ | adsorption | size | gradient | gradient | solvent/ |
| peptides | media | exclusion | solvent | initial | adsorption |
| targeted for | length | media | conc. | solvent | chrom. |
| separation | (cm) | length | slope | conc. | media |
| Porcine | 2 | 6 | -0.002 | 0.35 | Acetonitrile |
| insulin- | | | | | |
| desamido | | | | | |
| option 1 | | | | | |
| Porcine | 3 | 11 | -0.002 | 0.35 | Acetonitrile |
| insulin- | | | | | |
| desamido | | | | | |
| option 2 | | | | | |
| Porcine | 4 | 3 | -0.005 | 0.39 | Acetonitrile |
| insulin- | | | | | |
| desamido | | | | | |
| option 3 | | | | | |
| Insulin- | 2 | 6 | -0.001 | 0.3 | Acetonitrile/ |
| Desamido | | | | | C8 silica |
| ribonuc- | 2 | 4 | -0.001 | 0.39 | Acetonitrile/ |
| leaseA- | | | | | C8 silica |
| lysozyme | | | | | |

1. A novel chromatography purification system for protein or peptide solutes to be separated comprising:
a system containing multiple, greater than one, pairs of alternating adsorption chromatography media and size exclusion chromatography media in series with the outlet of each adsorption chromatography media section connected to the inlet of a size exclusion chromatography media section;
an adsorption chromatography media length, size exclusion chromatography media length, and a negative eluent gradient slope designed such that the gradient elution solvent concentration, relative to the protein/peptide positions, is increased by each size exclusion chromatography media section prior to the protein/peptide flow into the next adsorption chromatography media section;
a continued increase of the gradient eluent solvent concentration relative to the protein/peptide by each successive size exclusion chromatography media section to counteract the decrease of gradient eluent solvent concentration that occurs in each adsorption chromatography media section, with a size exclusion chromatography media length designed to control the extent of the differential migration of slower moving eluent gradient solvent molecules relative to faster moving protein/peptide molecules in the size exclusion chromatography medias;
a repositioned eluent gradient solvent concentration in each successive adsorption chromatography media section to continue the separation of the proteins/peptides by maintaining the eluent gradient solvent concentration in a range where interaction of the proteins/peptides occurs with the adsorption chromatography media.

2. The novel chromatography purification system of claim 1 comprising multiple short columns or one column with alternating media.

3. The novel chromatography system of claim 1 comprising an eluent gradient slope which is positive or negative.

4. (canceled)
